(19) United States
(12) Patent Application Publication
(10) Pub. No.: US 2009/0176466 A1
(43) Pub. Date: Jul. 9, 2009

(54) Apparatuses and a Method for Reducing Peak Power in a Transmitter of Telecommunications Systems

(75) Inventors: Richard Hellberg, Huddinge (SE); Torbjorn Widhe, Molndalm (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/373,316

(22) PCT Filed: Jul. 11, 2006
(86) PCT No.: PCT/SE2006/050256

§ 371 Date: Feb. 16, 2009

(30) Foreign Application Priority Data
Jul. 11, 2006 (SE) PCT/SE2006/050256

(51) Int. Cl. H04B 1/04

(52) U.S. Cl. 455/127.1

(57) ABSTRACT

The present invention relates to an apparatus (100) for reducing peak power in a transmitter for use in telecommunications systems. The invention also relates to a method for reducing peak power in a transmitter for use in telecommunications system and to a base station (500) including such an apparatus. An apparatus according to the invention includes successive processing stages (10); where each stage (10) has an input main signal (1). Each stage of said apparatus further includes a peak finder means (11) arranged to find at least one peak of said input main signal (1) based on a predetermined threshold level; a manipulation means (12) arranged to generate a scaled, rotated and shifted kernel signal (2) based on information on at least one peak of said input main signal (1); a combiner (13) arranged to subtract the scaled rotated and shifted kernel signal (2) from a delayed version of the input signal (1) generating thereof an output signal (4) having reduced peak or peaks; and said apparatus further characterized in that it comprises a fractional sample shifting means (20) arranged to apply a sample shifting on the output signal (4) from at least one of said successive processing stages (10).

### TECHNICAL FIELD

The present invention relates to signal processing in general and to a method and apparatuses for reducing peak power in a transmitter for use in telecommunications systems in particular.

### BACKGROUND

In many applications, various communications systems and especially in multi-carrier modulation systems there are requests for non-linear modification of a signal because multi-carrier signals suffer from a high-Peak-to-Average Ratio (PAR). Examples of such multi-carrier systems are Orthogonal Frequency Division Multiplexing (OFDM), Digital Audio Broadcasting (DAB) or Digital Video Broadcasting (DVB) to mention only a few. In many cases, such non-linear modifications have to be kept within a certain bandwidth or within certain spectral mask restrictions. In particular radio signal applications, this ensures that the output signal does not spill over into adjacent channels or exceeds spectral emission limits.

One typical example of such non-linear modification is PAR reduction. PAR reduction increases efficiency and average output power of a peak power limited Power Amplifier (PA). A large PAR brings disadvantages like a reduced efficiency of a Radio Frequency (RF) power amplifier and an increased complexity of analogue to digital and digital to analogue converters. The objective of peak reduction techniques is therefore to reduce the peak amplitude excursions of the output signal while keeping the spectrum expansion within specified limits, such as spectral mask and adjacent channel power ratio (ACPR) specifications, and keeping in-band error within specified limits, so-called error vector magnitude (EVM) specification.

There are many existing prior art solutions dealing with peak power reduction for multi-carrier signals and signal carrier signals.

One prior art approach for reducing the peak power of an input waveform is to implement power clipping. In the power clipping approach, whenever the amplitude of the input signal is lower than a predetermined threshold, the input signal is passed to the output unchanged, and whenever the amplitude of the input signal exceeds the threshold, the output signal is clamped to the threshold level. Of course, the clipping operation destroys some of the information contained in the original signal. However, the user should be able to tolerate this loss of information as along as the threshold is kept sufficiently high.

Decresting is another prior art approach for reducing the peak power of an input waveform, while avoiding the overshooting problems caused by the baseband filter in the power clipper. In this approach, which is suggested in the international patent application WO 03/001697, an error signal is created that represents the amount by which the input signal exceeds a threshold. This error signal is then subtracted from the original input signal in order to form a decrested output signal.

Tone reservation is another method used to reduce peak power of a signal, typically used when an input signal is a multi-carrier signal or a multi-tone signal. In this method, described in J. Tellado-Mourello, “Peak to Average Reduction For Multicarrier Modulation” Dept. of Electrical Engineering of Standford University, pp. 66-99, September 1999, the peak power is reduced by selecting or reserving a subset of a plurality of frequencies that constitute a multi-carrier symbol. These selected or reserved frequencies are used to create an appropriate impulse function, which is scaled, shifted, rotated and subtracted from the input multi-tone signal at each peak of the input signal that exceeds a predetermined threshold. Thus, one or several peaks may be clipped in this fashion and in a single iteration. However, reducing one or more peaks may cause the resulting waveform to exceed the clipping threshold at other positions. Therefore, the process is repeated until a satisfactory peak-to-average reduction is achieved. The impulse function created from the subset of reserved frequencies are usually pre-computed since the subset of reserved frequencies is usually known in advance. However, when non-linear processing as described in the above prior art forces a signal, such as a time-discrete signal, to stay within certain boundaries, this can generally only be guaranteed at sample instants. As the time-discrete signal (i.e. from digital form) is converted into time-continuous form (i.e into analogue form), peak regrowth occurs and therefore some limiting is needed in the analogue part of the system.

The traditional solution to this problem is to perform from the start the non-linear processing at a sufficiently high rate. In other words, peak regrowth can be avoided if a sufficiently high Over-Sampling Ratio (OSR) is used when starting processing the time-discrete signal. For example, in the tone reservation approach, typically four or higher OSR is usually used to make sure that peak regrowth is effectively avoided. This means that the computational complexity increases. In practical designs, the increase in computational cost is directly proportional to the OSR, and if an OSR of 4 is used, the computational cost increases by a factor of 4 and therefore a substantial increase in hardware and power consumption of a transmitter.

### SUMMARY

As stated above, a general problem with prior art solutions is that a high sample rate is needed in order to counteract peak regrowth when signals are converted to time-continuous form. This in turn requires more computational power, more hardware and an increase in power consumption.

An object of the invention is thus to provide apparatuses and a method for reducing peak power in a transmitter for use in telecommunications systems such that peak regrowth is effectively reduced even at low OSR and without any decrease in signal quality.

According to a first aspect of the invention, the above stated problem is solved by means of an apparatus for reducing peak power in a transmitter for use in telecommunications systems. The apparatus comprises successive processing stages. Each stage has an input main signal and an output main signal and comprises peak finder means for finding at least one peak of the input main signal exceeding a predetermined threshold level. Each stage of said apparatus further comprises manipulation means for generating a scaled, rotated and shifted kernel signal based on information regarding said at least one peak of the input main signal. Each stage further comprises a combiner arranged to reduce at least one peak of the input main signal by combining the scaled, rotated and shifted kernel signal with the input main signal, thereof generating an output signal. The apparatus according to the invention comprises a fractional sample shifting means for applying a fractional sample shift on the output signal from at least one of said successive processing stages.

According to a second aspect of the invention, the above stated problem is solved by means of a method for reducing peak power in a transmitter for use in telecommunications systems by non-linear processing of an input main signal using successive processing stages. The method comprises for each stage the steps of: finding at least one peak of the input main signal exceeding a predetermined threshold level; generating a scaled, rotated and shifted kernel signal based on information regarding said at least one peak of the input main signal; generating an output signal from the stage by reducing at least one peak of the input main signal through combination of the scaled, rotated and shifted kernel signal with the input main signal. The method according to the invention comprises the step of fractionally sample shifting the output signal from at least one of said successive stages.

According to a third aspect of the invention, the above stated problem is solved by means of a base station, which base station comprises an apparatus that reduces peak power in a transmitter for use in telecommunications systems.

An advantage with the present invention is that the computational load is effectively reduced.

Another advantage with the present invention is that hardware and power consumption of a base station is reduced.

The present invention will now be described in more details by means of preferred embodiments and with reference to the accompanying drawings.

### BRIEF DESCRIPTION OF THE DRAWINGS

FIG. 1 is a schematic block diagram of a first embodiment of an apparatus for reducing peak power according to the present invention.

FIG. 2 illustrates a schematic block diagram of an exemplary prior art apparatus for reducing peak power.

FIG. 3 is a schematic block diagram of an exemplary embodiment of a single stage in an apparatus for reducing peak power according to the present invention.

FIG. 4 is a schematic block diagram of an exemplary embodiment of an apparatus for reducing peak power according to the present invention.

FIG. 5 is a schematic block diagram of a second embodiment of an apparatus for reducing peak power according to the present invention.

FIG. 6 is a schematic block diagram of an exemplary embodiment of a fractional sample shift means according to the present invention.

FIG. 7 is a flowchart of a method according to the present invention.

FIG. 8 is a block diagram of an exemplary embodiment of a base station comprising an apparatus according to the present invention.

### DETAILED DESCRIPTION

The present invention provides apparatuses and a method for reducing peak power in a transmitter having as input a multi-carrier signal. The apparatus also decreases computational cost, power consumption and hardware of the transmitter. This is achieved by non-linear processing of an input main signal through successive processing stages that makes it possible to use either a low or high Over-Sampling Ratio (OSR) and which effectively reduces the peak power of the transmitter.

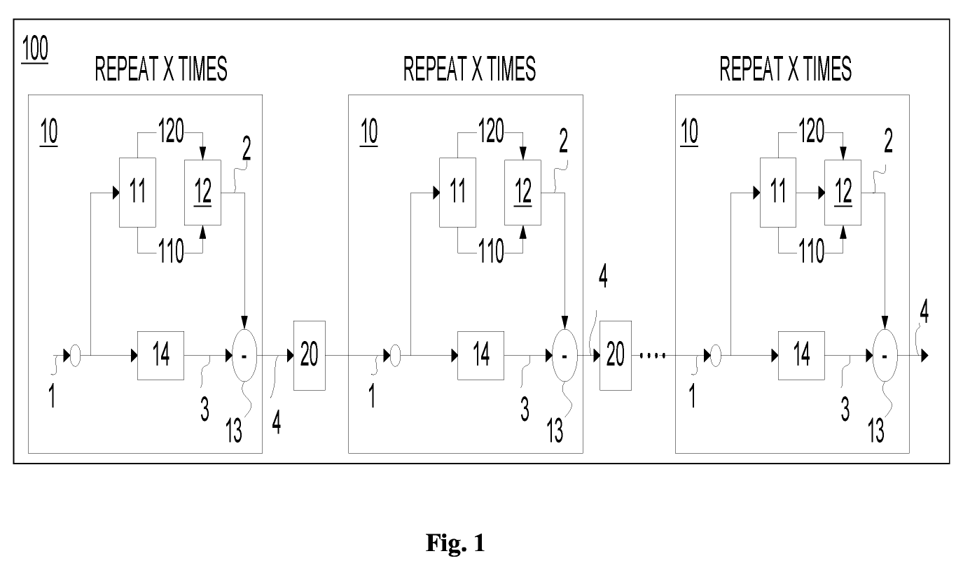

FIG. 1 illustrates an apparatus 100 according to a first embodiment of the present invention where a multi-stage non-linear processing of an input main signal 1 is performed. In a first processing stage 10, time-discrete samples of a multi-carrier signal are used as input values. These samples have a certain sample rate and thus a certain inter-sample spacing. Based on a predetermined threshold level A, also known as a clipping level, information on samples exceeding this threshold level is found by passing time-discrete samples of the input signal 1 through peak finder means 11. The information (110, 120) on sample or samples exceeding the threshold level includes: the size of the overshooting part exceeding the threshold level A, the phase and the position of this or these samples.

This information (110, 120) is further used to manipulate a kernel signal. The kernel signal is also referred to here as a peak-reduction signal, which after manipulation using the information (110, 120) on sample or samples exceeding the threshold level, reduces the peak power of the input signal by combining it using combiner 13 with a delayed version 3 of the original input main signal 1. Manipulation of the kernel signal is performed by a manipulation means 12.

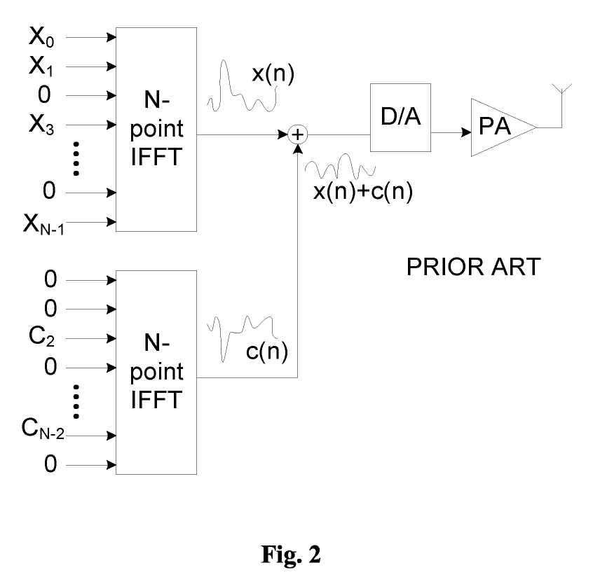

For better understanding the principles of peak power reduction using a kernel signal, an exemplary prior art technique will now be described in conjunction with FIG. 2.

FIG. 2 illustrates an exemplary prior art technique for reducing peak power of an input main signal using a kernel signal. In FIG. 2 an input main multi-carrier signal composed of {X₀, X₁, . . . X_{N-1}} originally in a frequency domain is converted into a time-discrete domain signal denoted x(n) using an N-point Inverse Fast Fourier Transformer. N is the number of sub-carriers of the original input signal, N can take any value depending on the desired data rate and other requirements on the system which the apparatus is to be integrated with. As can be seen in FIG. 2, some sub-carriers Xᵢ are equal to zero. These sub-carriers are known as reserved tones used to reduce the peak power of the system. These reserved sub-carriers or tones are usually not used for data transmission instead they are reserved for anti peak signals and they are orthogonal to the other tones which carry data. This technique is therefore known as the tone reservation technique. The reserved tones are further used to construct a reduction signal {C₁, C₂, . . . C_{N-1}} which is further passed through an N-point Inverse Fast Fourier Transformer in order to generate a time-discrete domain signal c(n) of similar size as x(n), i.e having the same number of samples as x(n), and adding this signal c(n) to the original time domain signal x(n) to cancel large peaks. This tone reservation technique restricts the data block {X₀, X₁, . . . X_{N-1}} and peak reduction block signal {C₁, C₂, . . . C_{N-1}} to lie in disjoint frequency subspaces i.e. XₖCₖ=0. This is illustrated in FIG. 2 where {C₁, C₂, . . . C_{N-1}} has zero values when {X₀, X₁, . . . X_{N-1}} has non-zero values and vice versa.

An exemplary process of reducing a single peak of x(n) exceeding a threshold level A will now be described:

An appropriate kernel signal k(n) is constructed from peak reduction frequencies or similarly from the reserved frequencies described above.

This kernel signal k(n) is further scaled at a peak time value τ using a scaling factor Δ. The scaling factor Δ corresponds to the magnitude of the overshooting part exceeding a threshold level A, and τ corresponds to the peak time-discrete value.

Now, to reduce the peak of x(n) at time τ, c(1) is constructed according to c(1)=A₁(Δ)·k(n−τ), where A₁(Δ) is a scaling factor greater than Δ such as for example 1.3Δ.

Thus, when x(n) and c(1) are added at n=τ would the maximum value be Δ−1.3Δ, which gives us a value less than the maximum (A−1.3Δ), and the peak has therefore been reduced.

The tone reservation technique described above repeatedly applies the kernel as described above to cancel the peaks of the input signal. Thus, any number of peaks may be clipped in this fashion and in a single iteration. However, reducing one or more peaks may cause the resulting waveform to exceed maximum value A at other sample positions. Therefore, the process may be repeated until a desired peak power is reached.

This prior art tone reservation technique described above has a drawback that before processing the input signal, an OSR of at least 4 is used to limit analogue peak-regrowth effects upon digital to analogue (D/A) conversion prior to forward the processed signal to the power amplifier (PA).

In order to overcome the above stated problem, either a high or low OSR, including an OSR equal to 1 could be used without affecting the quality of the processed input signal according to the present invention.

The embodiments of the present invention will now be described based on an input main multi-carrier signal having reserved frequencies and wherein the kernel signal is constructed based on the reserved frequencies of the input multi-carrier signal. It should be noted that the present invention is not restricted to a kernel signal constructed based on reserved frequencies.

Furthermore, the present invention is applicable in any type of communications systems utilizing multiple carries. By way of example, the invention applies to Orthogonal Frequency Division Multiplexing (OFDM), discrete Multi-Tone (DMT), Asymmetrical Digital Subscriber Line (ADSL), Digital Audio Broadcasting, Discrete Wavelet Multi-Tone (DWMT) or Digital Video Broadcasting (DVB) communications systems.

In order to achieve the desired results in reducing the peak power in a transmitter using the apparatus 100 of FIG. 1 in accordance with the present invention and without necessarily selecting a high OSR, it is of great importance to define the parameters that are used to describe the performance of frequency reservation schemes, also referred to as tone reservation schemes in accordance with the present invention:

The parameters are:

1) The percentage of tones or frequencies that are used for peak power reduction relative the number of overall frequencies. A greater number of reserved tones or frequencies provides better performance. However, as the number of reserved tones increases, more bandwidth is lost to peak power reduction signals. Thus, a trade-off must be made between performance and bandwidth. In addition to the percentage of tones or frequencies that are used, the distribution of the tones is also important. In practical designs, generally random distributions of the reserved tones perform much better than an evenly spaced tones or tones clustered, i.e. sequentially grouped in symbols that are to be transmitted. According to the present invention, a random distribution of the reserved tones or frequencies is used. However, any suitable distribution could be used.

2) The Peak-to-Average Ratio (PAR), where the average should be specified to whether it, in addition to the power of the non-reserved tones/frequencies, contains also the power of the reserved tones/frequencies or not.

3) The power in the reserved tones or frequencies relative the power in the non-reserved tones or frequencies.

4) The error in the non-reserved tones, usually specified, as mentioned earlier, in the form of the error vector magnitude (EVM) percentage. The choice of the EVM percentage is system specific and usually depends on the desired data rate to be used in the system.

According to exemplary embodiments of the present invention, the peak power may be defined as the point above which −56 dBc (c for carrier) of power exists for the total signal, i.e. all tones; and the average power is defined as the sum of the power in the non-reserved tones only. However, any other suitable definition of the peak power may be used, and the present invention is therefore not restricted to any specific definition of the peak power.

Note that the reserved tones or frequencies may be chosen by any suitable method. As an example, frequencies that are noisy may be utilized as peak power reductions tones since the decrease in data rate of the output symbol is minimised. The frequencies or tones may also be randomly selected.

According to the embodiments of the present invention, the subset of reserved frequencies or tones is chosen prior to transmission. This is done to avoid transmitting any side information to a receiver. In those embodiments no special receiver operation is needed.

In alternate embodiments, the subset of reserved frequencies may be reselected during communication depending on the quality of the channel or for any other reason. In this case, the receiver is informed on or originates the subset of reserved frequencies.

Furthermore and in accordance with embodiments of the present invention, the reserved frequencies or tones typically do not carry any useful information. Instead, the non-reserved frequencies are allowed to carry useful information. In alternate embodiments, the reserved frequencies may include some type of information. In those embodiments, the reserved frequencies are also decoded by the receiver.

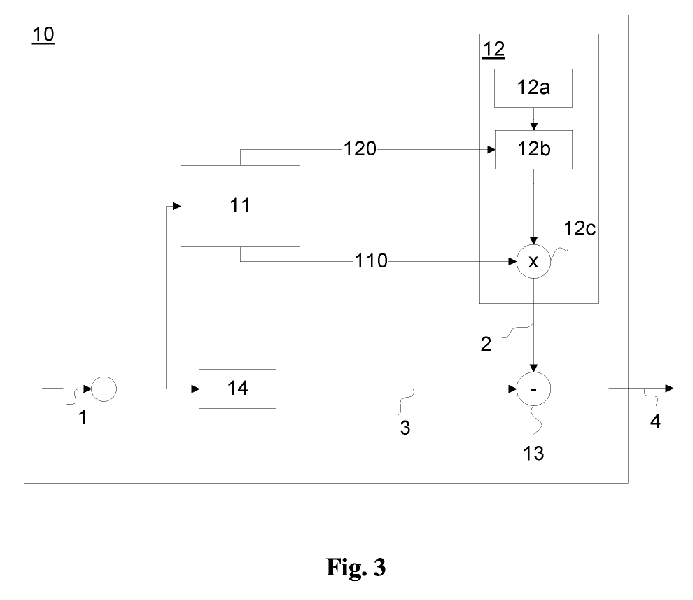

Referring back to FIG. 1, and in accordance with a first embodiment of the present invention each stage 10 of apparatus 100 consists of a number of X repeated find and reduce operations. In each find operation, peak finder means 11 finds a peak of the input main multi-carrier signal 1 based on a predetermined threshold level A. The information (110, 120) on found peak which includes the size, the phase and the time position is further used to scale, rotate, and shift a kernel signal 2 using a kernel manipulation means 12. For ease of viewing, a single stage 10 is illustrated in FIG. 3. The unmodified kernel signal, i.e. the signal before any manipulation is performed on it, is previously stored in a storage means 12a. The operation of scaling and rotating is performed by a scaling and rotating means 12c, whereas a shifting means 12b is responsible to cyclically shift the kernel signal.

After determining the scaled, rotated and shifted kernel signal 2, a delayed version 3 of the input signal 1 is combined with signal 2 using combiner 13, which further results in a output signal 4 having reduced peak. A delay means 14 is here applied on the original multi-carrier signal 1 because the processing of finding a peak and manipulating the kernel signal normally takes some processing time which should be compensated for. It should however be noted that the use of delay means 14 is not a prerequisite for the present invention.

When a number X of repeated find and reduce operations has been reached, a peak reduced signal 4 is forwarded to a fractional sample shifting means 20 that is arranged to apply a fractional sample shift on signal 4. It should be noted that X is not necessarily the same for all stages, and depends primarily on the number of peaks that have to be reduced but may also depend on other factors and can be elaborated for the problem at hand or by computer simulations.

The basic idea of applying a fractional sample shift on signal 4 is to delay the signal by a fraction of a sample in or between each stage 10, so that signal samples used in a later stage are placed in-between the sample instants used in a previous stage 10. In this way, a high OSR is not needed at the beginning of the processing of the input main multi-carrier signal. The fractional sample delays are preferably chosen differently for different systems depending on bandwidth, number of carriers, number of non-linear processing stages and other varying factors like those presented earlier.

As mentioned earlier, the computational complexity is reduced when a high OSR is not needed, and instead fractional sample shifting is applied.

As an example of the computational savings achieved using the apparatus 100 according to the present invention, two individual multi-carrier (OFDM) systems having equal performance, i.e. achieving the same reduction in the peak power are compared. The parameters used are:
a multi-carrier OFDM signal with 512 sub-carriers
a 5% reserved frequencies or tones (with a random distribution)
a 7% power overhead in the reserved frequencies relative the power in the non-reserved frequencies.
a 6.9 dB PAR at the −56 dBc point

For the conventional multi-carrier system an OSR of 4 is used. This system performed 25 peak reduction operations and 10 find operations. The computational complexity was in total 400 multiplications per symbol sample.

For the system using apparatus 100 according to the present invention, an OSR of 1 is used. The system performed 8 fractional sample shifts; 29 peak reduction operations and 16 find operations. The computational complexity was in total 250 multiplications per symbol sample.

Thus, the computational complexity has been reduced by approximately 38% using the apparatus 100 according to the present invention and without any decrease in signal quality, i.e. maintaining the same PAR of 6.9 dB.

In the present embodiment of FIG. 1, a fractional sample shifting means 20 is connected between the output of a preceding stage 10 and the input of a subsequent processing stage 10. The subsequent processing stage 10 will in the present embodiment perform a similar processing as in the first stage 10, but now with sample points located between the positions of the sample points of the first stage. After performing n stages of processing, the output signal from the last stage 10 is presented as the output signal of apparatus 100.

It should be noted that the actual place where the fractional sample shifting means 20 is introduced is system specific. The fractional sample shifting means 20 can for example be placed between two successive stages 10, placed within each stage 10, between every other stage 10 or according to some other scheme.

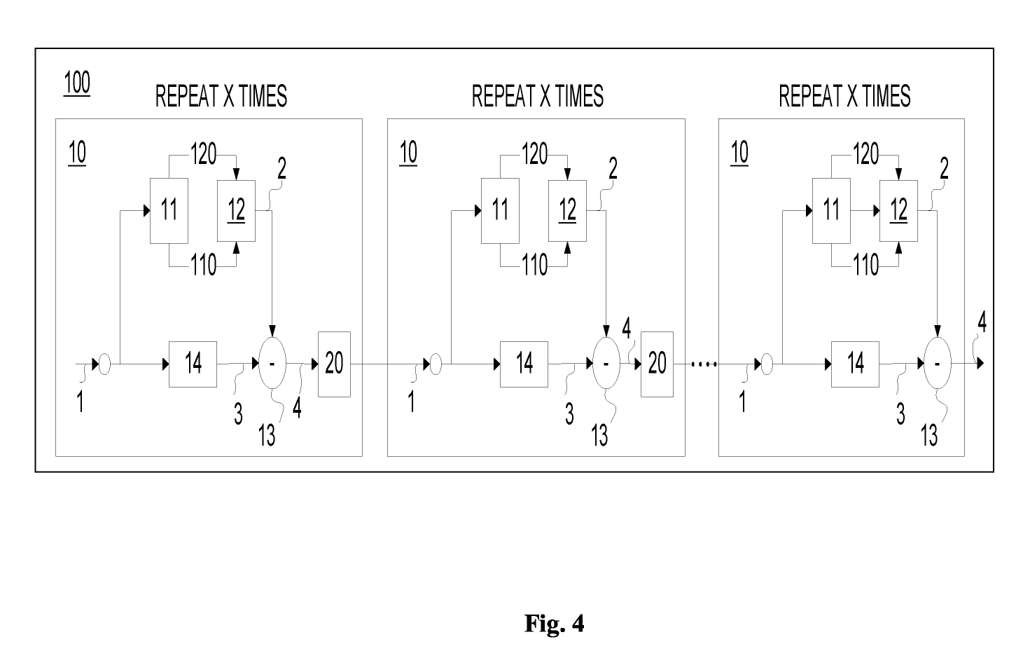

FIG. 4 illustrates a schematic block diagram of an exemplary embodiment of an apparatus 100 according to the present invention wherein the fractional sample shifting means 20 is placed within each successive stage 10. In a first stage 10, the input signal 1 is as in earlier embodiment passed through the peak finder means 11, where peak or peaks of the signal 1 are found based on a predetermined threshold level A. The information on said peak or peaks 110 and 120 are further used to generate a scaled, rotated and shifted kernel signal 2 and a combiner 13 is used to subtract the scaled, rotated and shifted kernel signal 2 from a delayed version of the input signal 1. Subsequently, a fractional sample shifting is performed on the combined signal 4, and an output signal 1 from the first stage 10 is used as input to a subsequent stage 10.

The above described process is repeated until a desired peak-to-average power ratio is achieved. Again, the use of a high OSR is not anymore a prerequisite which is the case in prior art solutions.

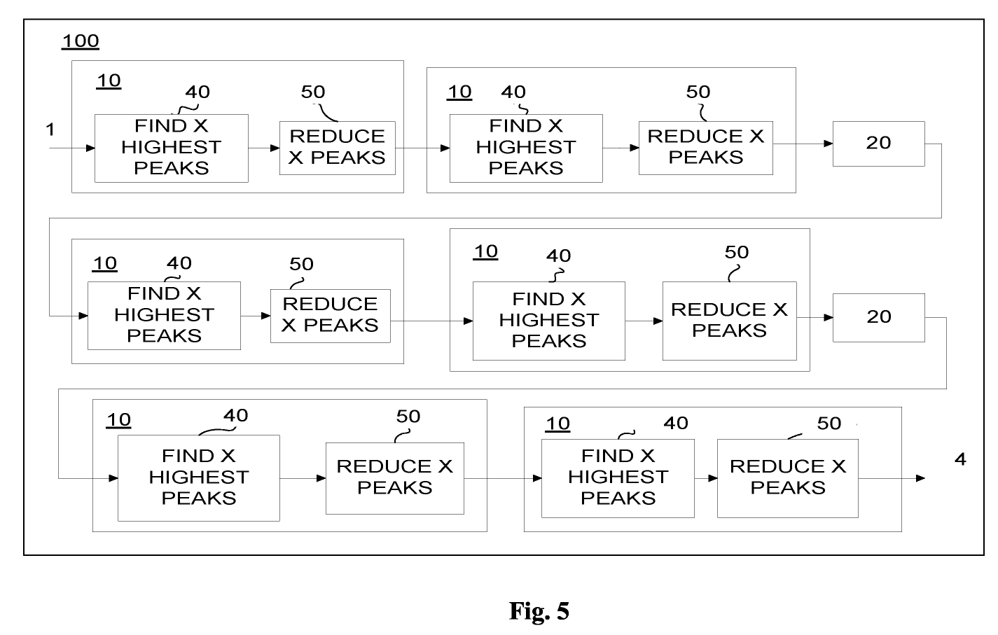

A second embodiment of the present invention is illustrated in FIG. 5. As depicted in FIG. 5, in each stage 10, the X highest peaks of the input main signal 1 are found in peak finder means 40 in a single operation based on a predetermined threshold level A. The peak finder means 40 in the present embodiment includes peak finder means 11 of FIG. 1, FIG. 3 or FIG. 4. When the X highest peaks have been found, information on these peaks are used by peak reduction means 50 to reduce the X highest peaks. The peak reduction means 50 thus includes the kernel manipulation means 12; the delay means 14 and the combiner 13 as previously shown FIG. 1, FIG. 3 or FIG. 4 and performs the same operation of reducing the X highest peaks according to the previous description. Again, the use of delay means 14 is not a prerequisite for the present invention according to the present embodiment.

After reduction of X highest peaks, a fractional sample shifting is performed by the fractional sample shifting means 20. The process is repeated in subsequent stages 10 before an output 4 with a desirable peak to average ratio is achieved.

As can be seen from FIG. 5, the fractional sample shifting means 20 is placed after every other stage 10 but no fractional sample shifting means 20 is used after the last stage 10.

Compared to the first embodiment, the computational complexity in this second embodiment is less when performing the find operations because in this embodiment X highest peaks are found in each stage 10. On the other hand, the computational complexity is little bit higher when performing the peak reduction operations because each of the X highest peaks are to be reduced in each stage. A greater number of peak reduction means 60 thus increases the computational complexity. Therefore, a trade-off must be made between computational complexity and performance. Still, the use of a higher OSR is not anymore a prerequisite using apparatus 100 according to the first or the other embodiments of the present invention.

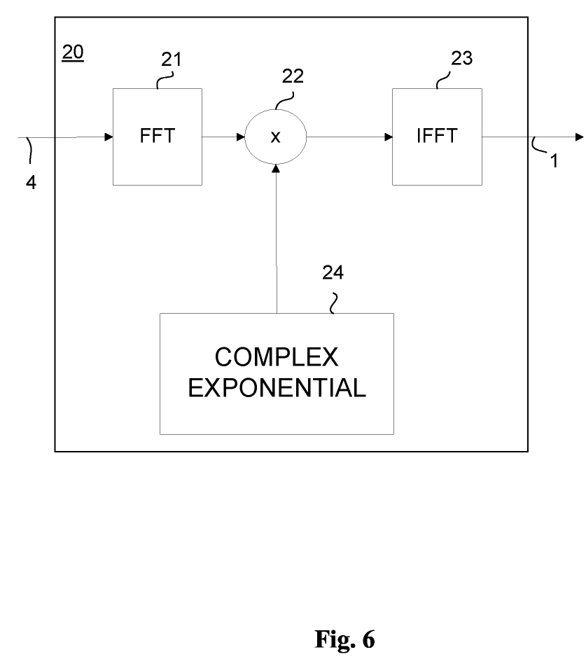

An exemplary embodiment of a single fractional sample shifting means 20 comprising a Fast Fourier Transformer (FFT) and an Inverse FFT (IFFT) is illustrated in FIG. 6.

It should be noted that the present invention is not restricted to FFT and IFFT operations in the fractional sample shifting means 20. Instead, the fractional sample shifting means 20 could be realised using non-FFT based operations such as using cyclic convolutions of the multi-carrier signal using FIR filters or IIR filters or a combination thereof. Alternatively, fast convolutions using the Agarwal-Cooly algorithm could also be used.

According to FIG. 6, the output signal 4 from a processing stage 10 is used as input main signal to the FFT means 21. The FFT means 21 then transforms the input signal from time-domain into discrete frequency domain. Thereafter, each frequency sample is at a multiplication means 22, multiplied by a complex function exp (−j*2*pi.*[frequency sample number]*[fractional shift]./N) generated by means 24. N is the number of frequency samples. An IFFT operation is then performed by the IFFT means 23 to bring the frequency domain signal back into a time-discrete domain signal 4 before forwarding it to a subsequent processing stage 10.

The major computational complexity of the FFT-based method lies in the FFT/IFFT computations. However, the computational complexity in hardware implementation can be reduced by efficient FFT structures especially if a small number of fractional sample shifts are used. In addition, the storage of the complex function can greatly be reduced by exploiting symmetry. Also, by having the number of equally-spaced sample fractions between subsequent processing stages 10 co-prime to the number of samples in the multi-carrier signal block, the number of complex values stored can be reduced to the number of fractions minus one. The range of frequency samples of the multi-carrier signal block are then multiplied by exp (−j*2*pi.*[frequency sample number]*[fractional shift]). Note here the dropped divide by N, which means that there are now a much lower number of different values in the complex exponentional. The computational complexity can be reduced with the above technique, especially if a small number of possible fractional shifts are used.

According to embodiments of the present invention, it is preferable to fractionally sample shift the samples of the input signal 1 as far away as possible from the present time shift, while going through successive processing stages 10. As an example, if apparatus 100 uses four fractional sample shifting means 20, the shifts could be [½, −¼, −½, ¼]. If only three shifts are performed, the shifts could be [⅓, −⅔, ⅓]. If five shifts are performed, the shifts could be [⅖, −⅗, ⅖, −⅗, ⅖]. A system with nine possible shifts out of which eight are used can have shifts of [ 4/9, − 6/9, 4/9, − 6/9, 3/9, 4/9, − 6/9, 3/9].

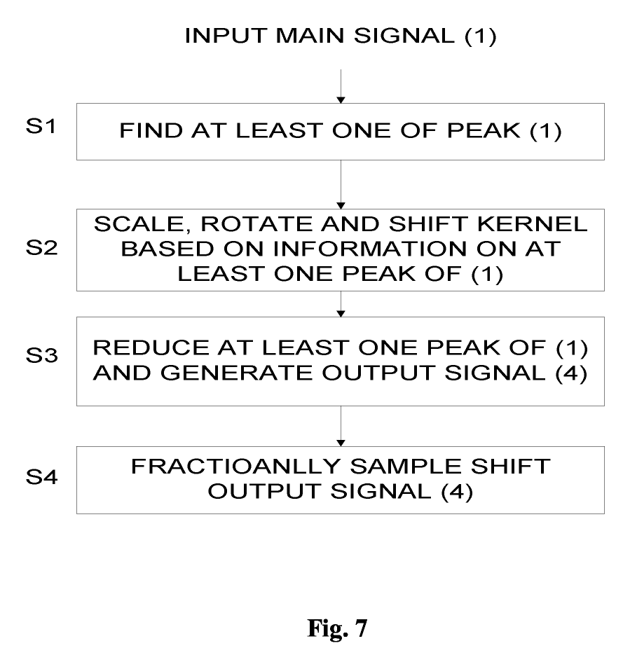

FIG. 7 illustrates a flowchart of a method for reducing peak power in a transmitter using successive processing stages 10 according to a second aspect of the present invention. In each stage 10, the following steps are performed:

At step S1, at least one peak of an input main signal 1 exceeding a predetermined threshold level is found.

At step S2, information on at least one peak of said input main signal 1 is used to scale, rotate, and shift a kernel signal 2.

At step S3, at least one peak of the input main signal 1 is reduced by combining the scaled, rotated and shifted kernel signal 2 with a delayed version of the input main signal 1, generating thereof an output main signal 4. Again, the input main signal 1 not necessarily delayed.

The method according to the invention comprises the step S4 of fractionally sample shifting the output signal 4 from at least one of said successive stages 10.

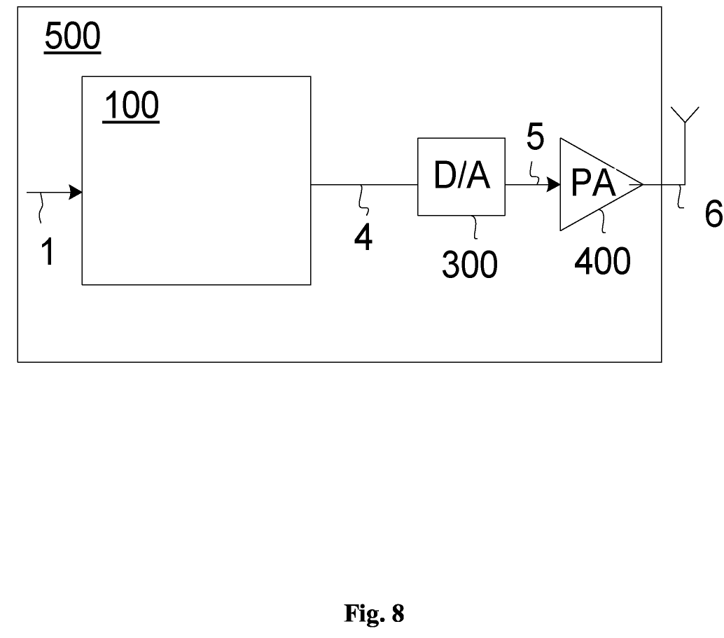

FIG. 8 illustrates a schematic block diagram of a third aspect of the present invention wherein an exemplary embodiment of a base station 500 comprises an apparatus 100 according to the present invention. In FIG. 8, elements that are not necessary for understanding the present invention have been omitted, such as for instance modulators, filters, encoders and other base station components. According to FIG. 8, an input main signal 1 is forwarded to apparatus 100 in accordance with the present invention. The output signal 4 from apparatus 100 is further converted into a time-continuous signal 5 by passing signal 4 through a digital to analogue converter (D/A) 300. The time continuous signal 5 is then forwarded to a power amplifier (PA) 400, and the output 6 of the PA is finally fed into an antenna prior to transmission.

With the present invention, non-linear processing of an input main signal can be performed either at a high or low OSR including an OSR equal to 1. Lower OSR means that fewer computations are needed to perform the same task as in prior art solutions. If a higher OSR is used, the fractional sample shifting means can be made shorter, and thus sectioned convolutions or even simpler interpolations methods can be used.

The main advantage of the invention is therefore a large reduction in computational cost, and as mentioned earlier, using an OSR of 1 instead of 4 reduces the computational load by a factor of 4. The complexity of computing cyclic fractional sample shifts is low in comparison with the decreased computational load.

A reduction in computational load leads to a further advantage of the present invention, namely a reduction in hardware and power consumption of a transmitter or a base station.

A person skilled in the art appreciates that the present invention can be realised in many ways. The various illustrative logical blocks described in connection with the embodiments disclosed herein may be implemented or performed with a general purpose processor, a digital signal processor (DSP), circuits, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, the processor may be any conventional processor, processor, microprocessor, or state machine. A processor may also be implemented as a combination of devices, e.g., a combination of a DSP and a microprocessor, a plurality of microprocessors, one or more microprocessors in conjunction with a DSP core, multiple logic elements, multiple circuits, or any other such configuration.

While the invention has been described in terms several preferred embodiments, it is contemplated that alternatives, modifications, permutations and equivalents thereof will become apparent to those skilled in the art upon reading of the specifications and study of the drawings. It is therefore intended that the following appended claims include such alternatives, modifications, permutations and equivalents as fall within the scope of the present invention.

1-39. (canceled)

40. An apparatus for reducing peak power in a transmitter used in telecommunications systems by non-linear processing of an input main signal, the apparatus having a plurality of successive processing stages, each stage comprising:
a peak finder component configured to find at least one peak of an input main signal exceeding a predetermined threshold level;
a manipulation component configured to generate a scaled, rotated, and shifted kernel signal based on information regarding the at least one peak of the input main signal;
a combiner configured to reduce the at least one peak of the input main signal by generating an output signal from a processing stage by combining the generated kernel signal with the input main signal; and
a fractional sample shifting component configured to apply a fractional sample shift to the output signal from at least one of the successive processing stages.

41. The apparatus of claim 40 wherein the fractional sample shifting component is interposed between successive processing stages.

42. The apparatus of claim 40 wherein the fractional sample shifting component is integrated within the processing stages.

43. The apparatus of claim 42 wherein the fractional sample shifting component is interposed between at least two successive processing stages.

44. The apparatus of claim 40 wherein the fractional sample shifting component is configured to allow at least one of the successive processing stages to find and reduce peak re-growth occurring between samples of the input main signal to at least one of the successive stages.

45. The apparatus of claim 40 wherein the peak finder component is configured to find, in a single operation, at least one highest peak of the input main signal exceeding a predetermined threshold level.

46. The apparatus of claim 45 wherein the manipulation component is configured to generate a scaled, rotated, and shifted kernel signal based on information regarding the at least one highest peak of said input main signal.

47. The apparatus of claim 45 wherein the manipulation component comprises memory configured to store the kernel signal.

48. The apparatus of claim 45 wherein the manipulation component further comprises a shifting component configured to cyclically shift the kernel signal based on information regarding the at least one highest peak of the input main signal.

49. The apparatus of claim 48 wherein the manipulation component further comprises a scaling and rotating component configured to scale and rotate the cyclically shifted kernel signal.

50. The apparatus of claim 40 wherein the combiner is configured to reduce at least one highest peak of the input main signal by generating an output signal from the stage by combining the scaled, rotated, and cyclically shifted kernel signal with a delayed version of said input main signal.

51. The apparatus of claim 40 wherein the fractional sample shifting component is configured to apply a fractional sample shift on the output signal from at least one of the successive processing stages after the at least one highest peak has been reduced.

52. The apparatus of claim 40 wherein the input main signal is a multi-carrier signal.

53. The apparatus of claim 46 wherein the input main signal is a multi-carrier signal having a subset of reserved frequencies, and wherein the subset of reserved frequencies is used to reduce the at least one peak of the input main signal.

54. The apparatus of claim 40 wherein the input main signal and the kernel signal comprise time domain samples.

55. The apparatus of claim 53 wherein the stored kernel signal is a function of the subset of reserved frequencies of the input main signal.

56. The apparatus of claim 55 wherein the information regarding the at least one peak of the input main signal comprises a position of the at least one peak of the input main signal, and wherein the kernel signal, being a function of the subset of reserved frequencies, is further configured to be rotated to be in phase with the at least one peak of the input main signal based on a determined phase of the at least one peak of the input main signal

57. The apparatus of claim 40 wherein the information regarding the at least one peak of the input main signal comprises:
a size of the at least one peak of the input main signal exceeding a predetermined threshold level;
a position of the at least one peak of the input main signal; and
a phase of the at least one peak of the input main signal.

58. The apparatus of claim 57 wherein the kernel signal is configured to be shifted such that at least one of its peaks occupy the same determined position of the at least one peak of the input main signal.

59. The apparatus of claim 57 wherein the kernel signal is further configured to be rotated to be in phase with the at least one peak of the input main signal based on a determined phase of the at least one peak of the input main signal.

60. The apparatus of claim 57 wherein the kernel signal is further configured to be scaled, based on the determined size, to have at least one of its peaks be a size similar to that of the at least one peak of the input main signal exceeding a predetermined threshold level.

61. A method for reducing peak power in a transmitter by non-linear processing of an input main signal using successive processing stages, wherein for each stage, the method comprises:
finding at least one peak of an input main signal exceeding a predetermined threshold level;
generating a scaled, rotated, and shifted kernel signal based on information regarding the at least one peak of the input main signal;
generating an output signal from the stage by reducing the at least one peak of the input main signal by combining the generated kernel signal and the input main signal; and
fractionally sample shifting the output signal from at least one of the successive processing stages.

62. The method of claim 61 wherein fractionally sample shifting the output signal is performed between the successive processing stages.

63. The method of claim 61 wherein fractionally sample shifting the output signal is performed within the successive processing stages.

64. The method of claim 61 wherein fractionally sample shifting the output signal is performed between at least two of the successive processing stages.

65. The method of claim 61 wherein fractionally sample shifting the output signal is performed such that the successive stages find and reduce, in at least one of the successive stages, peak re-growth occurring between samples of said the main signal to at least one of said successive stages.

66. The method of claim 61 further comprising finding, in a single operation, at least one highest peak of the input main signal exceeding a predetermined threshold level.

67. The method of claim 61 further comprising generating a scaled, rotated, and shifted kernel signal based on the information regarding the at least one highest peak of the input main signal.

68. The method of claim 61 further comprising storing the kernel signal.

69. The method of claim 61 further comprising cyclically shifting the kernel signal and rotating and scaling the cyclically shifted kernel signal based on information regarding at least one peak of said input main signal.

70. The method of claim 61 further comprising reducing each peak of the at least one highest peak of the input main signal by generating an output signal from the stage by combining the scaled, rotated, and cyclically shifted kernel signal from a delayed version of said input main signal.

71. The method of claim 61 further comprising fractionally sample shifting the output signal from at least one of the successive processing stages after the at least one highest peak has been reduced.

72. The method of claim 61 further comprising providing the input main signal with a subset of reserved frequencies, and wherein the subset of reserved frequencies is used to reduce one peak of the input main signal.

73. The method of claim 61 further comprising providing the input main signal and the kernel signal in the form of time domain samples.

74. The method of claim 72 wherein the kernel signal is provided as a function of the subset of reserved frequencies of the input main signal.

75. The method of claim 61 further comprising:
providing a size of the at least one peak of the input main signal exceeding a predetermined threshold level;
providing a position of the at least one peak of the input main signal; and
providing a phase of the at least one peak of the input main signal.

76. The method of claim 75 further comprising shifting the kernel signal such that at least one of its peaks are at the same position as that of the at least one peak of the input main signal.

77. The method of claim 75 further comprising rotating the samples of the kernel signal based on the provided phase of the at least one peak of the input signal such that the rotated samples of the kernel signal are in phase with the at least one peak of said input main signal.

78. The method of claim 75 further comprising scaling the samples of the kernel signal based on the provided size of the at least one peak of the input signal such that the kernel samples have at least one peak that is a size similar to the size of the at least one peak of the input main signal exceeding a predetermined threshold level.

79. A base station for a telecommunications system comprising an apparatus for reducing peak power, the base station comprising:
a device to reduce peak power in a transmitter used in the telecommunications system by non-linear processing of an input main signal, the device having a plurality of successive processing stages, each stage comprising:
a peak finder component configured to find at least one peak of an input main signal exceeding a predetermined threshold level;
a manipulation component configured to generate a scaled, rotated, and shifted kernel signal based on information regarding the at least one peak of the input main signal;
a combiner configured to reduce the at least one peak of the input main signal by generating an output signal from a processing stage by combining the generated kernel signal with the input main signal; and
a fractional sample shifting component configured to apply a fractional sample shift to the output signal from at least one of the successive processing stages;
